(19) United States
(12) Patent Application Publication
(10) Pub. No.: US 2026/0249367 A1
(43) Pub. Date: Aug. 27, 2026

(54) DEVICE FOR SHAPING A TUBULAR OBJECT

(71) Applicant: NUMALLIANCE, Saint-Michel-sur-Meurthe (FR)

(72) Inventor: Etienne Joël, Saint Dié des Vosges (FR)

(73) Assignee: NUMALLIANCE, Saint-Michel-sur-Meurthe (FR)

(21) Appl. No.: 19/489,634

(22) PCT Filed: Apr. 9, 2024
(86) PCT No.: PCT/EP2024/059630

§ 371 Date: Dec. 3, 2025

(30) Foreign Application Priority Data
Jun. 14, 2023 (FR) FR2306046

(51) Int. Cl. B23D 21/04

(52) U.S. Cl. CPC B23D 21/04

(57) ABSTRACT

The device (1) for shaping a tubular object has at least one shaper (2), a first rotary element (3) that includes the shaper (2) and a device (4) for movably mounting the shaper (2), a second rotary element (5), a drive (6) for rotating the first (3) and second rotary element (5), and a device (15) for moving the shaper (2). The drive (6) includes a first (7) and a second rotary motor (8); an epicyclic gear train (9) with a ring gear (90), a sun gear (91), at least one planet gear (92) and a planet carrier (93); a first input transmission (10) for transmitting a rotation of the first rotary motor (7) to the ring gear (90), a second input transmission (11) for transmitting a rotation of the second rotary motor (8) to the sun gear (91), a first output transmission (12) for transmitting a rotation of the ring gear (90) to the first rotary element (3) and a second output transmission (13) for transmitting a rotation of the planet carrier (93) to the second rotary element (5).

The present invention relates to a device for shaping a tubular object.

This invention relates to the field of tool manufacturing, more specifically machine tools, which are configured for shaping, more specifically for cutting, a tubular object, more specifically a tube, in particular metal.

Already, such devices for shaping a tubular object are known.

Such a shaping device is disclosed in the document FR 2,835,775. This shaping device comprises, on the one hand, a means of shaping the tubular object, and, on the other hand, a bearing means which is configured for bearing against the tubular object, and doing so diametrically opposite the shaping means. This shaping device comprises a first rotary element, which is rotationally mobile around a first axis of rotation, and which comprises, on the one hand, a first arm, on which an elbow is equipped with the shaping means, and also means of pivotably mounting this first arm within this first rotary element and, on the other hand, a second arm, on which an elbow receives a finger whose free end is equipped with the bearing means and which comprises means of adjusting the length of extension of this finger, and also means of pivotably mounting this second arm within this first rotary element. This shaping device further comprises a second rotary element, which is rotationally mobile around a second axis of rotation, and also means of pivotably driving the first and second arms, and doing so within the first rotary element and by the second rotary element. Finally, the shaping device comprises means of rotationally driving the first rotary element around the first axis of rotation and also the second rotary element around the second axis of rotation.

This device has a complex design. Further, in this shaping device, the pivoting amplitude of the first arm and the pivoting amplitude of the second arm are small such that this shaping device only serves to shape, successively, tubular objects with the same diameters. The shaping of two objects with different diameters requires, for each of these diameters, a course adjustment and a fine adjustment of the length of extension of the finger which is fastidious and time-consuming. Further, this shaping device comprises a single shaping means which wears quickly and whose replacement is fastidious and time-consuming.

The present invention even aims to remedy, at least in part, the disadvantages of the shaping devices from the state-of-the-art.

For this purpose, the invention relates to a device for shaping a tubular object. This shaping device comprises, on the one hand, at least one means of shaping a tubular object, on the other hand, a first rotary element, which is rotationally mobile around a first axis of rotation, and which comprises said at least one shaping means and also means of displaceably mounting said at least one shaping means within this first rotary element, again on the other hand, a second rotary element which is rotationally mobile around the second axis of rotation, also on the other hand, means of driving rotation which are configured for driving rotation of the first rotary element around the first axis of rotation and also the second rotary element around the second axis of rotation and, again on the other hand, means of driving displacement of said at least one shaping means, and doing so within the first rotary element and by the second rotary element.

The shaping device is characterized by the fact that the means of driving rotation comprises a first rotary motor and a second rotary motor as well as an epicyclic drive train which comprises a ring, a planet wheel, and at least one satellite and one satellite carrier. These means of driving rotation also comprise, on the one hand, first input transmission means which are configured for transmitting a rotational movement from the first rotary motor to the ring, on the other hand, second input transmission means which are configured for transmitting a rotational movement from the second rotary motor to the planet wheel, again on the other hand, first output transmission means which are configured for transmitting rotational movement from the ring to the first rotary element, and, also on the other hand, second output transmission means which are configured for transmitting a rotational movement from the satellite carrier to the second rotary element.

According to another characteristic, on the one hand, the first input transmission means comprise an input toothed wheel, which comprises a number of input teeth, and which is rotationally secured to the ring, on the other hand, the first output transmission means comprise a first output toothed wheel, which comprises a first number of output teeth, and which is rotationally secured to the ring and, again on the other hand, the second output transmission means comprise a second output gear, which comprises a second number of output teeth, and which is rotationally secured to the satellite carrier.

Another characteristic relates to the fact that the means of displaceably mounting said at least one shaping means comprise means of mounting in radial translation said at least one shaping means.

In fact, the means of mounting in radial translation comprise, on the one hand, at least one guiding path which comprises the first rotary element, on the other hand, at least one cart, that the first rotary element comprises, which engages with said at least one guiding path, and which receives said at least one shaping means.

Again, another characteristic relates to the fact that said first rotary element and/or said second rotary element comprise at least one lateral opening, which passes through, which is located in the extension of said at least one guiding path, and which is configured so as to allow the passage of said at least one cart.

Thus the shaping device conforming to the invention comprises a first rotary motor, a second rotary motor, and epicyclic drive train, (first and second) rotary elements and transmission means (input and output). These characteristics advantageously allow, on the one hand, providing an asynchronous rotation of the (first and second) rotary elements, more specifically for continuing with the shaping of the tubular object, on the other hand, providing an asynchronous rotation of the (first and second) rotary elements, and doing so with an advance of one relative to other to proceed with the displacement of said at least one shaping means in active shaping position and, also on the other hand, providing an asynchronous rotation of the (first and second) rotary elements, and doing so with a delay from one relative to the other to proceed with the displacement of said at least one shaping means in inactive shaping position.

According to another characteristic, the means of displaceably mounting said at least one shaping means comprise means of mounting in radial translation said at least one shaping means. These characteristics advantageously allow a large displacement amplitude for said at least one shaping means and, thus, the shaping of various tubular objects whose diameters also have a large amplitude, and doing so without coarse adjustment and/or fine adjustment and/or dismantling.

Again, another characteristic consists in that the first and/or the second rotary element have a through opening which advantageously allows extracting the cart provided with the shaping means (more specifically when it is worn) from the first rotary element in order for replacement thereof and engaging such a cart (in particular provided with a new shaping means) inside of the first rotary element, and doing so in a simple, quick and easy way.

Other goals and advantages of the present invention will become apparent through the following description relating to embodiments which are given as illustrative and nonlimiting examples.

Understanding of this description will be made easier by referring to the drawings attached in annex and on which:

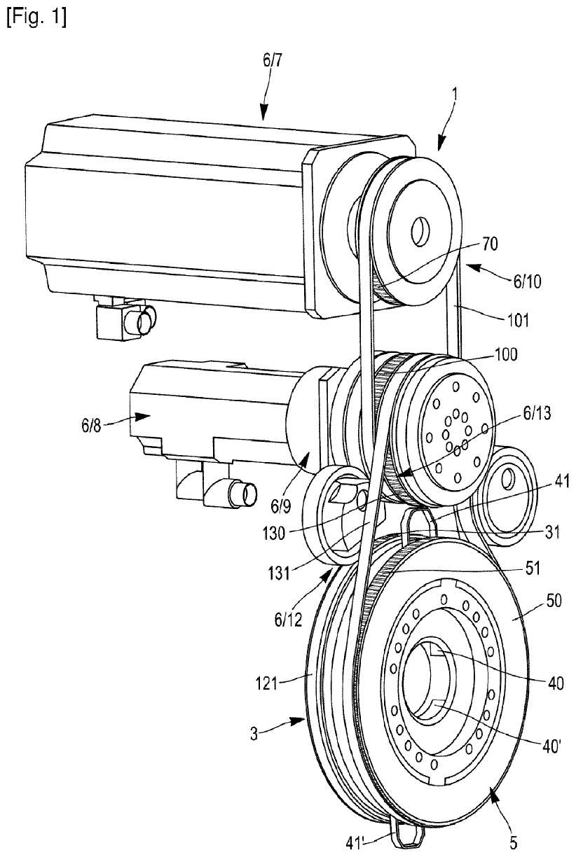

FIG. 1 shows a perspective view of a shaping device conforming to the invention.

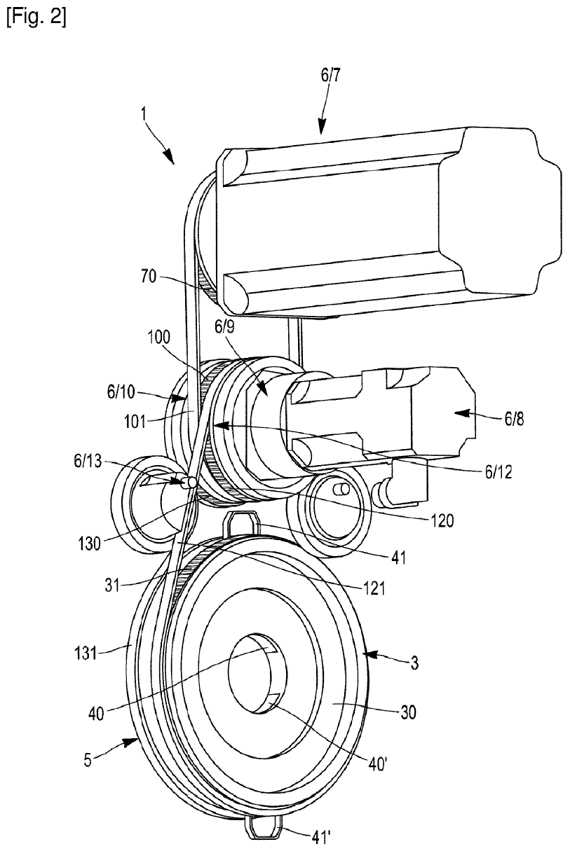

FIG. 2 shows a perspective view, according to another viewing angle, of the shaping device shown in FIG. 1.

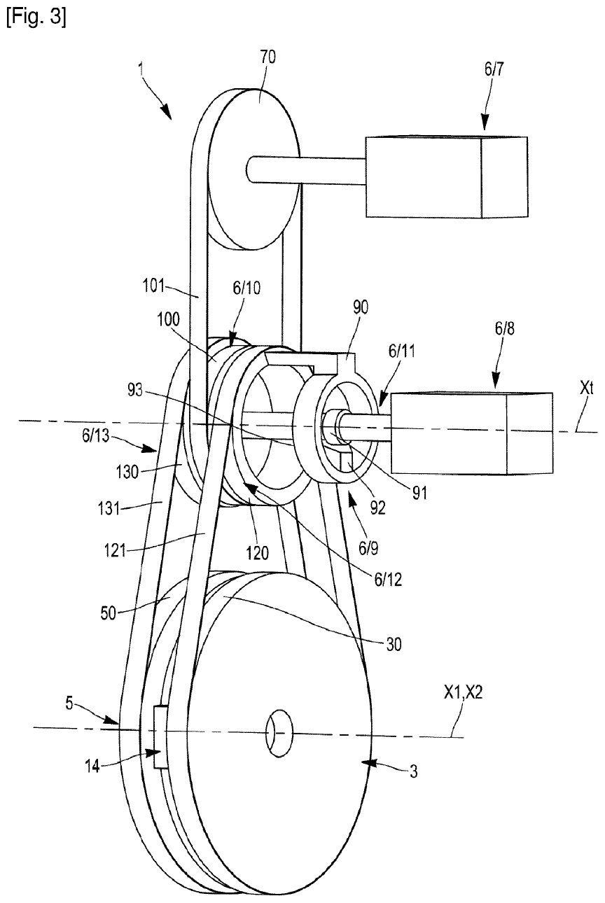

FIG. 3 is a schematic and perspective view of the shaping device shown in FIG. 2.

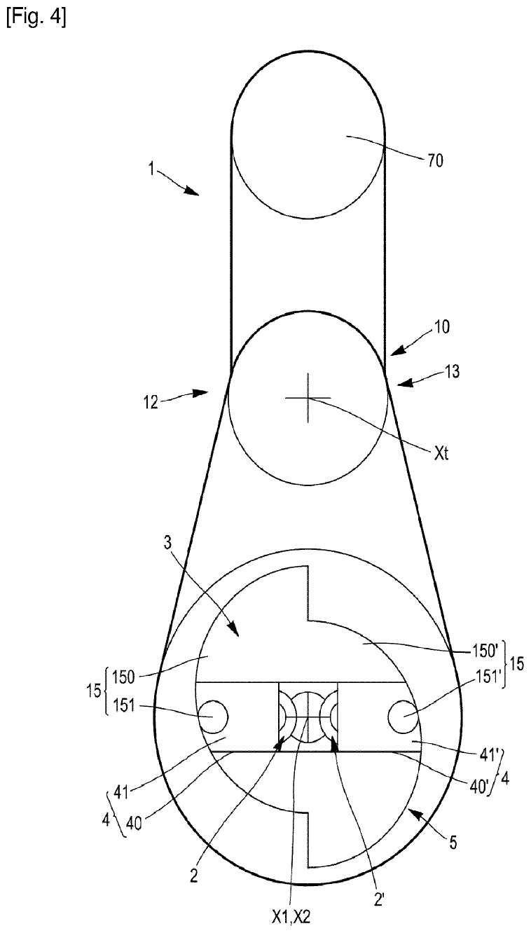

FIG. 4 shows a schematic view, in elevation and section of the shaping device conforming to the invention.

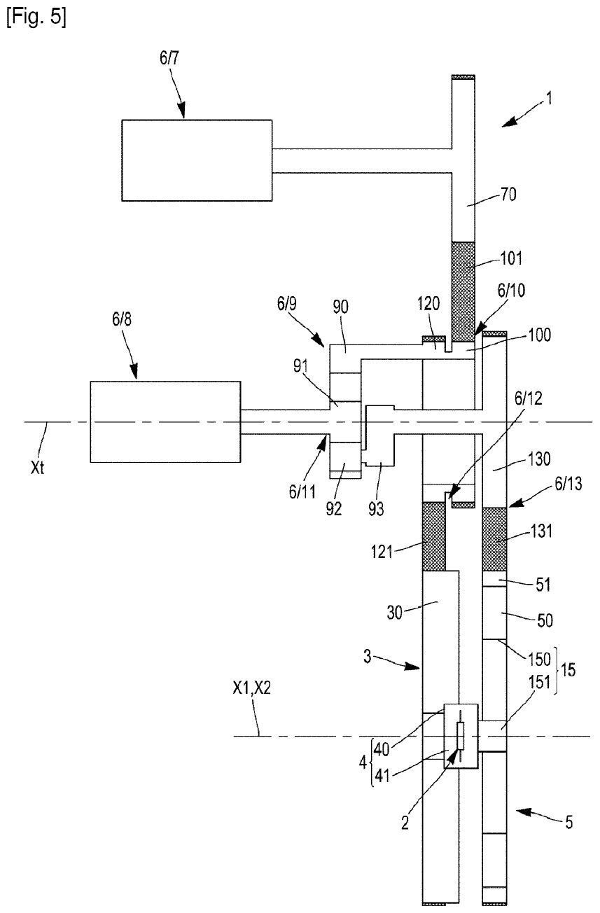

FIG. 5 is a schematic and side view of the shaping device conforming to the invention.

The present invention relates to the field of tool manufacturing, more specifically the field of manufacturing machine tools, which are configured for shaping, more specifically for cutting, a tubular object, more specifically a tube, in particular metal.

The invention thus relates to a device for shaping 1 a tubular object.

This shaping device 1 comprises at least one shaping means (2; 2′) for such a tubular object. According to a preferred embodiment of the invention, this shaping device 1 comprises two shaping means (2; 2′), whereas the shaping device 1 is configured so that these two shaping means (2; 2′) are positioned facing, and on both sides of the tubular object to be shaped. According to a preferred embodiment, such a shaping means (2; 2′) comprises (or is constituted of) a roller or the like.

This shaping device 1 also comprises a first rotary element 3 which is rotationally mobile around a first axis of rotation X1.

As can be seen in the attached figures, such a first rotary element 3 comprises at least one plate 30, which adopts a disk shape, and which is rotationally mobile around the first axis of rotation X1.

This first rotary element 3 also comprises said at least one shaping means (2; 2′) as well as means of displaceably mounting 4 which are configured for displaceably mounting said at least one shaping means (2; 2′) within this first rotary element 3.

Relating to this, it will be observed that the means of displaceably mounting 4 of said at least one shaping means (2; 2′) comprise means of mounting in radial translation said at least one shaping means (2; 2′).

In fact, these means of mounting in radial translation are configured for providing a mounting in radial translation said at least one shaping means (2; 2′), and doing so in the direction of a radius which passes by the first axis of rotation X1.

As can be seen in FIGS. 4 and 5, these means of mounting in radial translation comprise, on the one hand, at least one guiding path (40; 40′) that the first rotary element 3 comprises, more specifically that the plate 30, which the first rotary element 3 comprises, comprises. Said at least one guiding path (40; 40′) may take on the shape of a rail, a groove or the like. Said at least one guiding path (40; 40′) extends radially, and doing so in the direction of a radius which passes by the first axis of rotation X1.

On the other hand, these means of mounting in radial translation comprise at least one cart (41; 41′), that the first rotary element 3 comprises, which engages with said at least one guiding path (40; 40′), more specifically which is mobile relative to said at least one guiding path (40; 40′), more specifically which slides relative to said at least one guiding path (40; 40′), in particular inside said at least one guiding path (40; 40′).

More specifically, it is such a cart (41; 41′) which receives (more specifically which is equipped with) said at least one shaping means (2; 2′).

Relating to this, it will be observed that, according to a preferred embodiment of the invention, these means of displaceably mounting 4 (more specifically these means of mounting in radial translation), on the one hand, are configured for displaceably mounting two shaping means (2; 2′) within this first rotary element 3 (in the way mentioned above and symmetrically about the first axis of rotation X1) and, on the other hand, comprise two guiding paths (40; 40′) and also two carts (41; 41′). In this case, these two guiding paths (40; 40′) are symmetric about the first axis of rotation X1 and are located one (40; 40′) in the extension of the other (40′; 40).

According to another characteristic, the shaping device 1 again comprises a second rotary element 5 which is rotationally mobile around a second axis of rotation X2. The second axis of rotation X2 is at least parallel to the first axis of rotation X1, or even coincident with this first axis of rotation X1. As can be seen in the attached figures, this second rotary element 5 is positioned opposite the first rotary element 3.

This second rotary element 5 may comprise at least one plate 50 which adopts a disk shape, and which is rotationally mobile around the second axis of rotation X2.

Again another characteristic relates to the fact that the shaping device 1 also comprises means of driving rotation 6 which are configured for driving rotation of the first rotary element 3 around the first axis of rotation X1 and also the second rotary element 5 around the second axis of rotation X2.

Relating to this, it will be observed that these means of driving rotation 6 comprise a first rotary motor 7 (which comprises a stator and a rotor which is rotationally mobile relative to the stator and also about an axis of rotation which is at least parallel to the first axis of rotation X1 and/or the second axis of rotation X2) and a second rotary motor 8 (which comprises a stator and a rotor which is rotationally mobile relative to the stator and also about an axis of rotation which is at least parallel to the first axis of rotation X1 and/or the second axis of rotation X2).

These means of driving rotation 6 again comprise an epicyclic drivetrain 9 which comprises a ring 90 (more specifically which is rotationally mobile around an axis of rotation Xt which is at least parallel to the first axis of rotation X1 and/or the second axis of rotation X2), a planet wheel 91 (more specifically which is rotationally mobile around an axis of rotation which is at least parallel to the first axis of rotation X1 and/or the second axis of rotation X2 and/or to the axis of rotation Xt around which the ring 90 is rotationally mobile, or even coincident with the axis of rotation Xt around which the ring 90 is rotationally mobile), at least one satellite 92 (more specifically which engages with the ring 90 and also with the planet wheel 91 and which is rotationally mobile around an axis of rotation which is at least parallel to the first axis of rotation X1 and/or the second axis of rotation X2 and/or to the axis of rotation Xt around which the ring 90 is rotationally mobile), and one satellite carrier 93 (more specifically which receives said at least one satellite 92 and which is rotationally mobile around an axis of rotation which is at least parallel to the first axis of rotation X1 and/or the second axis of rotation X2 and/or to the axis of rotation Xt around which the ring 90 is rotationally mobile or even coincident with the axis of rotation Xt around which the ring 90 is rotationally mobile).

These means of driving rotation 6 again comprise, on the one hand, first input transmission means 10 which are configured for transmitting a rotational movement from the first rotary motor 7 to the ring 90, on the other hand, second input transmission means 11 which are configured for transmitting a rotational movement from the second rotary motor 8 to the planet wheel 91, again on the other hand, first output transmission means 12 which are configured for transmitting rotational movement from the ring 90 to the first rotary element 3, and, also on the other hand, second output transmission means 13 which are configured for transmitting a rotational movement from the satellite carrier 93 to the second rotary element 5.

Relating to this, it will be observed that, on the one hand, the first input transmission means 10 comprise an input toothed wheel 100, which comprises a first number of input teeth NE1, and which is rotationally secured to the ring 90 (more specifically in rotation around the axis of rotation Xt around which this ring 90 is rotationally mobile), on the other hand, the first output transmission means 12 comprise a first output toothed wheel 120, which comprises a first number of output teeth NS1, and which is rotationally secured to the ring 90 (more specifically around the axis of rotation Xt around which this ring 90 is rotationally mobile) and, again on the other hand, the second output transmission means 13 comprise a second output gear 130, which comprises a second number of output teeth NS2, and which is rotationally secured to the satellite carrier 93 (more specifically around the axis of rotation Xt around which this ring 90 is rotationally mobile).

Relating to this, it will be observed that the first number of input teeth NE1 and the first number of output teeth NS1 are, preferably, identical.

Again, another characteristic relates to the fact that the first rotary motor 7 comprises a toothed wheel 70.

Alternatively or (and preferably) additionally, the first rotary element 3 comprises a toothed wheel 31.

Alternatively or (and preferably) additionally, the second rotary element 5 comprises a toothed wheel 51.

Specifically, the toothed wheel 31 of the first rotary element 3 and the toothed wheel 51 of the second rotary element 5 may comprise the same number of teeth.

According to a first embodiment not shown, the toothed wheel 70 of the first rotary motor 7 engages (more specifically directly) with the input toothed wheel 100 of the first input transmission means 10. Alternatively or (and preferably) additionally to this first embodiment, the toothed wheel 31 of the first rotary element 3 engages (more specifically directly) with the first output toothed wheel 120 of the first output transmission means 12. Alternatively or (and preferably) additionally to this first embodiment, the toothed wheel 51 of the second rotary element 5 engages (more specifically directly) with the second output toothed wheel 130 of the second output transmission means 13.

According to a second embodiment shown in the attached figures, the first input transmission means 10 again comprise at least one belt 101, in particular notched. Alternatively or (and preferably) additionally in this second embodiment, the first output transmission means 12 again comprise at least one belt 121, in particular notched. Alternatively or (and preferably) additionally in this second embodiment, the second output transmission means 13 again comprise at least one belt 131, in particular notched.

Also and according to another characteristic, the belt 101 of the first input transmission means 10 at least engages with the input toothed wheel 100 of the first input transmission means 10, even with the toothed wheel 70 of the first rotary motor 7.

Alternatively or (and preferably) additionally, the belt 121 of the first output transmission means 12 engages with the first output toothed wheel 120 of the first output transmission means 12, or again even with the toothed wheel 31 of the first rotary element 3.

Alternatively or (and preferably) additionally, the belt 131 of the second output transmission means 13 engages with the second output toothed wheel 130 of the second output transmission means 13, or again even with the toothed wheel 51 of the second rotary element 5.

According to another characteristic, the first output transmission means 12 have a first transmission ratio, whereas the second output transmission means 13 have a second transmission ratio.

Also and according to another characteristic, the first transmission ratio of the first output transmission means 12 and the second transmission ratio of the second output transmission means 13 are configured such that the first rotary element 3 and the second rotary element 5 turn synchronously.

To do that and according to a specific embodiment, the second number of output teeth NS2 is greater than the first number of output teeth NS1. According to a specific embodiment, the first number of output teeth NS1 is 99 whereas the second number of output teeth NS 2 is 100. In such a case, the number of teeth on the toothed wheel 31 of the first rotary element 3 may be equal to the number of teeth on the toothed wheel 51 of the second rotary element 5.

However and according to another embodiment, the number of teeth on the toothed wheel 31 of the first rotary element 3 is greater than the number of teeth on the toothed wheel 51 of the second rotary element 5. In such a case, the second number of output teeth NS2 may be equal to the first number of output teeth NS1.

As mentioned above, the shaping device 1 comprises means for displaceably mounting 4 said at least one shaping means (2; 2′) which comprise means of mounting in radial translation said at least one shaping means (2; 2′) which comprise at least one guiding path (40; 40′) and also at least one cart (41; 41′).

Relating to this, it will be observed that, according to an additional characteristic, said first rotary element 3 and/or said second rotary element 5 comprise at least one lateral opening 14, which passes through, which is located in the extension of said at least one guiding path (40; 40′), and which is configured so as to allow the passage of said at least one cart (41; 41′). The presence of such a lateral opening 14 serves, advantageously, the extraction of the at least one part of such a cart (41; 41) from the first rotary element 3 (in particular to fully extract it from this first rotary element 3 for replacement of it and/or replacement of the sharpening means 2; 2′ thereof) and also the insertion of such a cart (41; 41′) inside this first rotary element 3.

The shaping device 1 again comprises means for driving displacement 15 which are configured for driving said at least one shaping means (2; 2′), and doing so within the first rotary element 3 and by the second rotary element 5.

In fact, these means of driving displacement 15 are, more specifically, configured for driving said at least one shaping means (2; 2′), and doing so between at least one inactive shaping position and at least one active shaping position.

Relating to this, it will be observed that these means of driving displacement 15 are, then, more specifically, configured for driving said at least one cart (41; 41′), and doing so between at least one such inactive shaping position and at least one such active shaping position.

Additionally, these means of driving displacement 15 may again be configured for driving said at least one cart (41; 41′) from a position withdrawn inside the first rotary element 3 and a position at least partially deployed outside the first rotary element 3, more specifically through said at least one lateral opening 14.

These means of driving displacement 15 comprise (or are even constituted by) means of driving radial translation (more specifically in the direction of a radius which passes through the first axis of rotation X1) of said at least one shaping means (2; 2′), more particularly said at least one cart (41; 41′).

According to a specific embodiment, these means of driving displacement 15 of said at least one shaping means (2; 2′) comprise, on the one hand, at least one cam (150; 150′) that the second rotary element 5 comprises (more specifically that the plate 50 comprises that this second rotary element 5 comprises) and, on the other hand, at least one follower (151; 151′), which engages with said at least one cam (150; 150′), and that the first rotary element 3 comprises, more specifically that the means of displaceably mounting 4 comprise, more specifically that the means of mounting in radial translation comprise, in particular said at least one cart (41; 41′). Such a follower (151; 151′) may adopt the shape of a roller, a stop, a post or the like.

In the remainder of the description, the operation of the shaping device 1 will be described with reference to the technical characteristics described above.

According to a first embodiment of the shaping device 1, the first rotary motor 7 is running whereas the second rotary motor 8 is stopped.

In this first mode of operation, the first rotary element 3 and the second rotary element 5 turn synchronously, more specifically because of the appropriate configuration of the first transmission ratio of the first output transmission means 12 and the second transmission ratio of the second output transmission means 13 such as described above.

According to a second embodiment of the shaping device 1, the first rotary motor 7 is stopped whereas the second rotary motor 8 is running.

In this second embodiment, the means of driving displacement 15 (more specifically said at least one cam 150; 150′) drive displacement (in radial translation) of said at least one shaping means (2; 2′), more specifically between a position of said at least one cart (41; 41′) retracted inside the first rotary element 3 and a position of said at least one cart (41; 41′) at least partially deployed outside of the first rotary element 3 (more specifically through said at least one lateral opening 14) and inversely.

According to a third embodiment of the shaping device 1, the first rotary motor 7 and the second rotary motor 8 are operating, more specifically continuously.

In this third embodiment of operation, the means of driving displacement 15 (more specifically said at least one cam 150; 150′) drive displacement (in radial position) of said at least one shaping means (2; 2′), and do so, either between at least one inactive shaping position and at least one active shaping position, or between at least one active shaping position and at least one inactive shaping position, as a function of the direction of rotation of the second rotary motor 8.

1. A shaping device for tubular object, wherein the shaping device comprises:
at least one means of shaping a tubular object,
a first rotary element, which is rotationally mobile around a first axis of rotation, and which comprises the at least one shaping means and means of displaceably mounting the at least one shaping means within the first rotary element,
a second rotary element which is rotationally mobile around a second axis of rotation,
means of driving rotation which are configured for driving rotation of the first rotary element around the first axis of rotation and the second rotary element around the second axis of rotation, and
means of driving displacement of the at least one shaping means within the first rotary element by the second rotary element,
wherein the means of driving rotation comprises:
a first rotary motor;
a second rotary motor;
an epicyclic drive train which comprises a ring, a planet wheel, at least one satellite and a satellite carrier;
first input transmission means which are configured for transmitting a rotational movement from the first rotary motor to the ring,
second input transmission means which are configured for transmitting a rotational movement from the second rotary motor to the planet wheel,
first output transmission means which are configured for transmitting rotational movement from the ring to the first rotary element, and
second output transmission means which are configured for transmitting a rotational movement from the satellite carrier to the second rotary element.

2. The shaping device according to claim 1, wherein
the first input transmission means comprise an input toothed wheel, which comprises a number of input teeth, and which is rotationally secured to the ring,
the first output transmission means comprise a first output toothed wheel, which comprises a first number of output teeth, and which is rotationally secured to the ring, and
the second output transmission means comprise a second output gear, which comprises a second number of output teeth, and which is rotationally secured to the satellite carrier.

3. The shaping device according to claim 2, wherein a first number of input teeth and a first number of output teeth are identical.

4. The shaping device according to claim 1, wherein a first transmission ratio of the first output transmission means and a second transmission ratio of the second output transmission means are configured so that the first rotary element and the second rotary element turn synchronously.

5. The shaping device according to claim 4, wherein
the first input transmission means comprise an input toothed wheel, which comprises a number of input teeth, and which is rotationally secured to the ring,
the first output transmission means comprise a first output toothed wheel, which comprises a first number of output teeth, and which is rotationally secured to the ring, and
the second output transmission means comprise a second output gear, which comprises a second number of output teeth, and which is rotationally secured to the satellite carrier,
and wherein the second number of output teeth is greater than the first number of output teeth.

6. The shaping device according to claim 1, wherein the first rotary motor and/or the first rotary element and/or the second rotary element comprise(s) a respective toothed wheel.

7. The shaping device according to claim 6, wherein
the first input transmission means comprise an input toothed wheel, which comprises a number of input teeth, and which is rotationally secured to the ring,
the first output transmission means comprise a first output toothed wheel, which comprises a first number of output teeth, and which is rotationally secured to the ring, and
the second output transmission means comprise a second output gear, which comprises a second number of output teeth, and which is rotationally secured to the satellite carrier,
and wherein
the toothed wheel of the first rotary motor engages with the input toothed wheel of the first input transmission means, and/or
the toothed wheel of the first rotary element engages with the first output toothed wheel of the first output transmission means, and/or
the toothed wheel of the second rotary element engages with the second output toothed wheel of the second output transmission means.

8. The shaping device according to claim 6, wherein
a first transmission ratio of the first output transmission means and a second transmission ratio of the second output transmission means are configured so that the first rotary element and the second rotary element turn synchronously, and
a number of teeth on the toothed wheel of the first rotary element is greater than a number of teeth on the toothed wheel of the second rotary element.

9. The shaping device according to claim 1, wherein the first input transmission means and/or the first output transmission means and/or the second output transmission means comprise at least one belt.

10. The shaping device according to claim 9, wherein
the first input transmission means comprise an input toothed wheel, which comprises a number of input teeth, and which is rotationally secured to the ring,
the first output transmission means comprise a first output toothed wheel, which comprises a first number of output teeth, and which is rotationally secured to the ring, and
the second output transmission means comprise a second output gear, which comprises a second number of output teeth, and which is rotationally secured to the satellite carrier,
and wherein
the belt of the first input transmission means at least engages with the input toothed wheel of the first input transmission means, and/or
the belt of the first output transmission means engages with the first output toothed wheel of the first output transmission means, and/or
the belt of the second output transmission means engages with the second output toothed wheel of the second output transmission means.

11. The shaping device according to claim 1, wherein the means for displaceably mounting the at least one shaping means comprise means for mounting the at least one shaping means in radial translation.

12. The shaping device according to claim 11, wherein the means of mounting the at least one shaping means in radial translation comprise
at least one guiding path which comprises the first rotary element, and
at least one cart, wherein the first rotary element comprises the at least one cart, which engages with the at least one guiding path, and which receives the at least one shaping means.

13. The shaping device according to claim 12, wherein the first rotary element and/or the second rotary element comprise at least one lateral opening, wherein the at least one lateral opening passes through, is located in an extension of the at least one guiding path, and is configured to allow passage of the at least one cart.

14. The shaping device according to claim 1, wherein the means of driving displacement of the at least one shaping means comprise
at least one cam, wherein the second rotary element comprises the at least one cam, and
at least one follower, which engages with the at least one cam, wherein the first rotary element comprises the at least one follower.

15. The shaping device according to claim 9, wherein the at least one belt is notched.

16. The shaping device according to claim 2, wherein a first transmission ratio of the first output transmission means and a second transmission ratio of the second output transmission means are configured so that the first rotary element and the second rotary element turn synchronously.

17. The shaping device according to claim 16, wherein
the first input transmission means comprise an input toothed wheel, which comprises a number of input teeth, and which is rotationally secured to the ring,
the first output transmission means comprise a first output toothed wheel, which comprises a first number of output teeth, and which is rotationally secured to the ring, and
the second output transmission means comprise a second output gear, which comprises a second number of output teeth, and which is rotationally secured to the satellite carrier,
and wherein the second number of output teeth is greater than the first number of output teeth.

18. The shaping device according to claim 3, wherein a first transmission ratio of the first output transmission means and a second transmission ratio of the second output transmission means are configured so that the first rotary element and the second rotary element turn synchronously.

19. The shaping device according to claim 18, wherein
the first input transmission means comprise an input toothed wheel, which comprises a number of input teeth, and which is rotationally secured to the ring,
the first output transmission means comprise a first output toothed wheel, which comprises a first number of output teeth, and which is rotationally secured to the ring, and
the second output transmission means comprise a second output gear, which comprises a second number of output teeth, and which is rotationally secured to the satellite carrier,
and wherein the second number of output teeth is greater than the first number of output teeth.

20. The shaping device according to claim 2, wherein the first rotary motor and/or the first rotary element and/or the second rotary element comprise(s) a respective toothed wheel.
